(19) United States
(12) Patent Application Publication
(10) Pub. No.: US 2002/0136136 A1
(43) Pub. Date: Sep. 26, 2002

(54) Method for storing data using VCSEL device

(76) Inventor: Daniel Gelbart, Vancouver (CA)

Correspondence Address: Dan Gelbart, Creo Products Inc., 3700 Gilmore Way, Burnaby, V5G 4M1, CA

(21) Appl. No.: 09/816,450

(22) Filed: Mar. 26, 2001

(51) Int. Cl. G11B 7/00

(52) U.S. Cl. 369/59.11; 369/121

(57) ABSTRACT

In accordance with the present invention, a large number of data tracks are recorded on an optical recording media using a vertical cavity surface emitting laser (VCSEL) array. By selecting the number of laser array elements to exceed the number of recorded tracks, an increase in the recording density is possible by modulating the width, as well as length, of each recorded mark.

### CROSS-REFERENCE TO RELATED APPLICATIONS

Not applicable

### Statement Regarding Federally sponsored R&D

Not applicable

### Reference to Microfiche Appendix

Not applicable

### FIELD OF THE INVENTION

The invention relates to optical data storage, and in particular to multi-track disc and tape system, both of the erasable and non-erasable type.

### BACKGROUND OF THE INVENTION

Multi-track recording and readout is well known in the art of optical data storage. The principles of this technique are well established in the optical data storage disk field. Optical tape recording equipment have also benefited from the multi-track approach to data storage. A commercial product, the Creo Optical Tape Recorder, sold by Creo Products (Burnaby, BC, Canada) from 1991 to 1996 incorporates these features as well as electronic tracking of the data.

The use of mark length and mark width encoding in such systems has also been described, for example by Gelbart in U.S. Pat. No. 5,802,034. In that particular work, a light valve is employed to create multiple optical channels from a single laser device and the channels are intentionally designed to be below the limit of the optical resolution of the optical subsystem of the recorder. In this way multiple light valve channels were used to compose a single recording channel. This allowed the width of a recording mark to be modulated in order to provide an additional means of binary encoding.

Prior art recording of multiple tracks used scanning, a plurality of laser sources, acousto-optic modulators and other light valves. These methods have inherent trade-offs and shortcomings when the number of channels becomes large and in moving subsystems.

The advent of laser devices of the VCSEL type, fabricated to resonate and emit with good conversion efficiency and comparatively low beam divergence normal to the epitaxial layer structure of the device wafer, has made possible the manufacture of high efficiency laser arrays. In principle the incorporation of a VCSEL laser array can make possible recording heads with faster random access and tracking.

While the VCSEL devices represent a major advance in technology, their application, at the time of this application for letters patent, is very much focused on optical communications. In particular, VCSEL array devices are fabricated to obtain massively parallel optical communication data paths. As a result, the devices are optimized for this kind of application. One way in which this optimisation manifests itself, is that the individual laser emission faces on array devices are separated by distances of the order of 250 microns, while the diameter of a typical VCSEL emission face is of the order of 15 microns. There is a lower limit to the reduction in separation between VCSEL elements. Part of this space is demanded by device structures central to the functioning of the lasers . This separation is quite practical for optical communications applications where individual optical fibers ultimately are coupled to the individual devices. However, this is a major impediment in applying the devices in applications where a more contiguous emission pattern or “footprint” is required.

Some innovation adaptation is therefore required to apply VCSEL devices to their greatest advantage in non-communications applications such as optical recording.

An object of the present invention is to apply the benefits of VCSEL devices to the field of optical recording in a fashion that leads to highest possible information density.

### BRIEF SUMMARY OF THE INVENTION

In accordance with the present invention, a large number of data tracks are recorded on an optical recording media using a vertical cavity surface emitting laser (VCSEL) array. By selecting the number of laser array elements to exceed the number of recorded tracks, an increase in the recording density is possible by modulating the width, as well as length, of each recorded mark.

### BRIEF DESCRIPTION OF THE DRAWINGS

FIG. 1 is a schematic of the preferred embodiment of the present invention

FIG. 2 is a schematic representation of the mark width and length encoding.

FIG. 3 shows the recording format according to the present invention.

### DETAILED DESCRIPTION OF THE PREFERRED EMBODIMENT

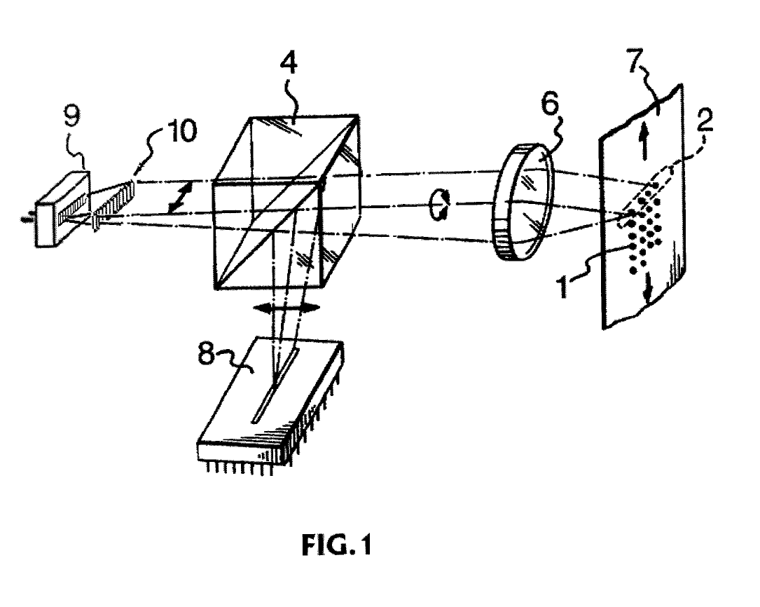

FIG. 1 shows the preferred embodiment of the present invention. Vertical cavity surface emitting laser (VCSEL) array 9 generates a row of light beams from a row of individual laser elements, each representing a channel. Micro lens array 10 converges these light beams and performs what is known as “aperture filling”. This has the effect of generating an equivalent array of light sources with tighter spacing. The image of the row of lasers is focused by lens 6 onto optical recording media 7 at a high reduction ratio. Lens 6 has an auto-focus mechanism (not shown) that is used to overcome the shallow depth of focus of such a lens. Between VCSEL array 9 and lens 6 a reflective non-polarizing beam splitter 4 is used in order to divert a percentage of the light reflected from optical media 7 onto detector array 8. It is desirable to use a 90%/10% or 80%/20% splitter instead of the common 50%/50% splitter. This ensures that a maximum percentage of data writing power from the VCSEL array reaches the recording media, whilst still producing a reflective signal that may be used to read recorded data.

In order to read recorded data, VCSEL array 9 is turned on at a reduced intensity, or a separate read VCSEL array is used. VCSEL array 9 has all channels enabled, in order to image a line of light 2 across tracks 1 on optical media 7. The light reflected from the recorded surface of media 7 is partially reflected by beam splitter 4 to reach detector array 8. Both VCSEL array and detector array 8 are at conjugate image planes to the data tracks 1. Additional lenses can be used in the optical path to match the image size to the detector size and to obtain practical inter-component distances.

For details of the multi-track readout method, see U.S. Pat. No. 5,081,617 hereby incorporated in full. These methods are well known and incorporated in a commercial product, the Model 1012 Optical Tape Recorder by Creo Products (B.C., Canada).

The recorded data rates can be very high, as the relative motion between the optical media and the writing beam need not be fast if a sufficiently large number of tracks is recorded in parallel. The high power conversion efficiencies and modulation speeds attainable from VCSEL devices also aid the rate at which information may be recorded.

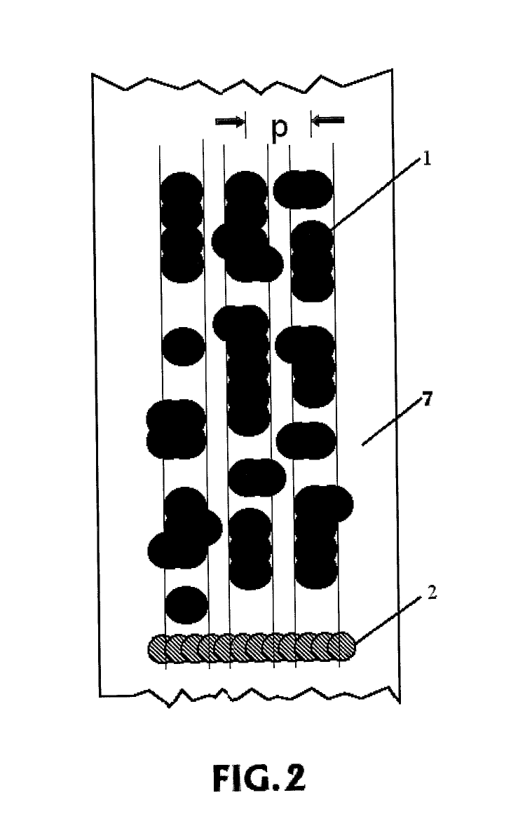

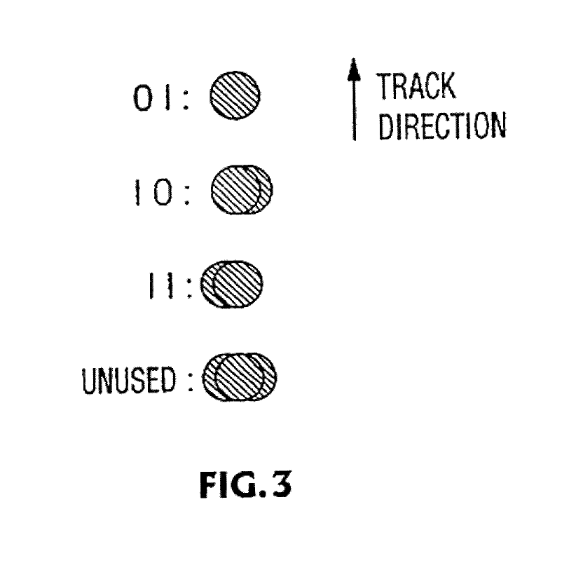

The preferred embodiment of the present invention also incorporates a method for increasing the recording density by using not only mark length modulation, as is commonly used in the prior art, but by modulating the mark width, as described by Gelbart in U.S. Pat. No. 5,802,034 and shown in FIG. 2 and FIG. 3.

Referring now to FIG. 1 and FIG. 2, VCSEL array 9 contains a plurality of channels for each track of recording. In FIG.2 the pitch of data tracks 1 is shown as “p”. VCSEL array 9 has multiple channels, typically four, per pitch “p”. Each one of these channels, when imaged in isolation, is smaller than the resolving power of the objective lens 6 in FIG. 1, the lens having been specifically selected such that it cannot resolve a single laser channel. The line of unresolved individual laser channel images of VCSEL array 9 is shown as line of light 2 on optical recording media 7. If a plurality of adjacent channels is turned on, the area will be sufficiently large to be fully resolved and recorded.

In an alternative embodiment of the present invention, the final lens 6 is capable of resolving a single laser channel, but an individual laser channel has inadequate power to write a mark on the media by itself, and at least two partly overlapping laser channel images are used to provide enough power for the writing process.

In FIG. 2 the smallest mark, a substantially round dot, corresponds to the resolving power of the optical system in the first embodiment of the present invention described above. Similarly, in the alternative embodiment, the smallest mark corresponds to the mark produced by two laser channels when these partially coincide to produce enough power to write a mark on the media. In the general case either of the two mechanisms, or a combination of both, may be used to obtain a mark.

To record data in which the mark length (in the scan direction determined by the motion of the recording medium) is varied but the mark width remains constant, the laser channels of the VCSEL array are divided into identical groups. In the example given in FIG.2 every two laser channels are grouped together.

In order to achieve increased data density by modulating the width of the mark, the number of VCSEL array channels has to be larger than the number of data tracks 1. In FIG. 2, by way of example, the VCSEL array 9 has four channels per data track and the minimum number of channels required to form a clearly resolvable spot on the media is two. When two out of four laser channels are turned on, a mark of a minimal width is formed. This mark can be made wider to one side by turning on an extra laser channel, adjacent to the two already on. The mark can be widened on the other side by turning on another laser channel on the other side of the original channels. In order to obtain maximum power performance, the laser elements assigned to a given data track may be mutually phase-locked.

The five possibilities of changing the mark width in the preferred embodiment of the present invention have been described by Gelbart in U.S. Pat. No. 5,802,034, which is hereby incorporated in full, and are shown in FIG. 3. To represent the binary combination “00” no channels are on and no mark is formed. “01 ” is represented by a minimal mark width, formed when two channels are turned on. “10” is formed when three laser channels are turned on, using the original two plus the adjacent channel from the right. “11” is formed when three channels are turned on, using the original two plus the adjacent channel form the left.

If four channels were turned on, an even wider mark could be formed. It is clear from the encoding of FIG. 3 that more than two bits of information can be carried within one trackwidth. One alternate scheme, having even more states, is based on the following combination of four lasers: 0000, 0011, 0110, 1100, 0111, 1110, and 1111. To get the full capacity for this alternate scheme, a base-7 number system has to be used.

A similar scheme is applied to the mark length in the conventional way. Combining both mark length and width modulation the number of bits per mark can be three, four, or even five. Coding rules (known as “run length limitations”) similar to those that apply to the mark length encoding also apply to the mark width, although the encoding methods for the length and width can differ. Only the simplest mark-width encoding scheme was chosen as an example shown by FIGS. 2 and 3.

It is clear to those versed in the art that more complex width coding schemes can be used, in particular when more channels are assigned to a data track. Even in the simple example of FIG. 3 an alternate coding scheme is possible, in which the “no mark” state is not used and the minimum mark width represents “00” while the maximum width represents “11”. It is also clear that the field-of-view of detector array 8 exceeds the width of data tracks if electronic tracking of the data (as in U.S. Pat. No. 5,081,617) is required. If no tracking and no width modulation is required, the number of data tracks can be equal to the number of detector channels. In the preferred embodiment, the number of detectors greatly exceeds the number of tracks. This is done both for accurate tracking and for accurate determination of mark width.

Referring now to FIG. 1, by the way of example, the components in the preferred embodiment are:

A. VCSEL array 9: The array has twelve laser elements with apertures of the order of 15 microns diameter with a 250 micron element-to-element pitch in a linear array emitting at 850 nm. The total die length is 3150 microns. In the preferred embodiment of the present invention, four laser elements are dedicated per data channel. Every four channels form a single-track pitch, thus three tracks are recoded simultaneously. One supplier of VCSEL arrays of this type is Emcore of Somerset, N.J., USA.

B. Micro lens array 10: This micro lens array has a focal length of 1 mm, with a lens-lens pitch of 249.989 microns and is located approximately 1 mm from VCSEL array 9 such that each beam fills a micro lens aperture. One supplier of micro lens arrays of this type is United Technologies Adaptive Optics of Cambridge, Mass. USA.

C. Beam Splitter 4: 90%/10% non-polarizing beam-splitter available, for example, from Melles-Griot of Irvine, Calif., USA.

D. Final lens 6: This lens is a molded aspheric lens of focal length 3.1 mm and N.A.=0.68. An example of this kind of lens is supplied by Geltech of Orlando, Fla. USA as part number 350330.

E. Read detector array 8: C-MOS detector array with 128 channels (twelve for reading the data, rest for tracking) with a channel pitch is identical to the pitch of VCSEL array channels. Read detector array details including calibration are similar to the one used on the Creo Optical Tape Recorder model 1012. A supplier of such read detector arrays is Orbit Semiconductors (Mountain View, Calif.).

The above combination and placement of components as in FIG.1 results in a distance of 1937.5 mm between the micro lens array 10 and final lens 6. While this is functional, a configuration with a smaller inter-component distance may be more desirable for commercial products. To address this matter, a reverse telescopic optical subsystem may be placed between the micro lens array 10 and the beam splitter 4. For example, to reduce the micro lens-to-final lens distance to a more practical value of 194 mm, a 10×reduction reverse telescopic sub-system, in which a lens of focal length 100 mm is combined with a convex lens of focal length −10 mm, is placed between the micro lens array and the beamsplitter.

The placement of the optical elements in FIG. 1 is chosen in order to achieve tracks of width 1.6 microns, with each track comprising four laser channels of 0.4 microns each. The smallest recorded mark size is about 0.8 microns. A single VCSEL does not have the power to form a mark, as 0.4 microns is below the resolution of the optical system.

While the system is suitable for any type of optical media, the preferred embodiment uses phase change optical tape available from Kodak (Rochester, N.Y.) and Polaroid (Cambridge, Mass.) or phase change optical discs.

In this preferred embodiment of the present invention a linear VCSEL array of 12 elements is employed. In a more general case the array can have more elements, and the number of laser channels per data track may be greater. In a yet more general case any combination of VCSELs, such as a two-dimensional array or slanted linear array can be used to decrease the apparent pitch of the VCSEL array. Such methods are well known in the art and in other fields such as inkjet printing.

One of the advantages of the present invention subsists in the fact that VCSEL devices have a very high conversion efficiency. This combined with the light weight of a typical microlens system, makes it possible to incorporate the VCSEL array and micro-lens combination into the actual moving part of an rapidly tracking optical subsystem. This is not possible with typical prior art devices that require either cooling systems or a light valve. Both of these add considerable weight and force the designer to remove these components from the rapidly tracking subsystem of the recording head.

There has thus been described the important features of the invention in order that it may be better understood, and in order that the present contribution to the art may be better appreciated. Those skilled in the art will appreciate that the conception on which this disclosure is based may readily be utilized as a basis for the design of other apparatus to embody the invention. It is most important, therefore, that this disclosure be regarded as including such equivalent apparatus as do not depart from the spirit and scope of the invention.

What is claimed is

1. A method for recording on a radiation sensitive medium using a modulated vertical cavity surface emitting laser array having a plurality of laser elements, wherein a plurality of said laser elements is used to form any single mark on said radiation sensitive medium, said method comprising varying the width of each mark in the data track by selecting which of said laser elements are activated.

2. A method as in claim 1, wherein said change in width is used as a method of data encoding.

3. A method as in claim 1, wherein the minimum number of laser elements used to form a resolvable mark on said radiation sensitive medium is greater than one.

4. A method as in claim 1, wherein the emitted power of a minimum number of laser elements is used to create a mark on said radiation sensitive medium and said minimum number of laser elements is greater than one.

5. A method as in claim 1, wherein the individual laser elements that are turned on are phase-locked to form a coherent beam.

6. An optical data storage recording head for recording at least one data track, said recording head comprising
a. at least one vertical cavity surface emitting laser array,
b. a recording medium sensitive to imaging radiation so as to form image marks in response to incidence of the imaging radiation and
c. an imaging assembly located intermediate said laser array and said recording medium operative to focus radiation from said vertical cavity surface emitting laser array onto said recording medium so as to record image marks thereon, wherein said laser array has a plurality of laser elements for said data track in order to change the width of said track by varying the number of laser elements that are turned on to form said track.

7. An optical data storage recording head as in claim 6, wherein the storage density of data recorded on said recording medium is increased by varying of the number of laser elements that is turned on.

8. An optical data storage recording head as in claim 6, wherein the minimum number of laser elements used to form a resolvable mark on said radiation sensitive medium is greater than one.

9. A method as in claim 6, wherein the emitted power of a minimum number of laser elements is used to create a mark on said radiation sensitive medium and said minimum number of laser elements is greater than one.

10. An optical data storage recording head as in claim 6, wherein the individual laser elements that are turned on are phase-locked to form a coherent beam.
